(19) United States
(12) Patent Application Publication
(10) Pub. No.: US 2012/0031849 A1
(43) Pub. Date: Feb. 9, 2012

(54) AERATED REACTOR APPARATUS AND METHODS

(75) Inventor: Ahren Britton, Vancouver (CA)

(73) Assignee: OSTARA NUTRIENT RECOVERY TECHNOLOGIES INC., Vancouver (CA)

(21) Appl. No.: 13/021,677

(22) Filed: Feb. 4, 2011

Related U.S. Application Data
(60) Provisional application No. 61/302,054, filed on Feb. 5, 2010.

(51) Int. Cl. C02F 1/52; C02F 1/68; C02F 1/66; C02F 1/58

(52) U.S. Cl. 210/696; 210/150; 210/96.1; 210/194; 210/220; 210/702

(57) ABSTRACT

A reaction tank useful for precipitating struvite from aqueous solutions such as wastewater comprises an aeration system. The aeration system includes air diffusers in the reaction tank. The air diffusers are located at a level below an outlet of the reaction tank. The airflow control mechanism comprises means for automatically controlling the flow of the stripping gas from the diffusers. The airflow control mechanism may be configured to automatically control the flow of stripping gas in response to a signal from a sensor measuring the pH of the aqueous solution the alkalinity of the aqueous solution or the concentration of dissolved carbon dioxide in the aqueous solution.

### CROSS REFERENCE TO RELATED APPLICATIONS

This application claims the benefit under 35 U.S.C. §119 of U.S. Patent Application No. 61/302,054 filed on 5 Feb. 2010 and entitled AERATED REACTOR APPARATUS AND METHODS which is hereby incorporated herein by reference

### TECHNICAL FIELD

The invention relates to water treatment. Embodiments relate to reactors for precipitating dissolved materials from water. For example, the invention may be applied in struvite precipitation reactors.

### BACKGROUND

Reactors in general and fluidized bed reactors in particular have been used to remove and recover phosphorous from aqueous solutions that contain significant concentrations of phosphorus, often in the form of phosphate. Such aqueous solutions may come from a wide range of sources. These include sources such as leaching from landfill sites, runoff from agricultural land, effluent from industrial processes, municipal wastewater, animal wastes, and the like. Such solutions, if released into the environment without treatment, can result in excess effluent phosphorus levels.

Various phosphorus removal and recovery technologies exist. Some of the technologies provide fluidized bed reactors for removing phosphorus from aqueous solutions by producing struvite (MgNH₄PO₄.6H₂O) or struvite analog or a phosphate compound in the form of pellets. Struvite can be formed by the reaction:

Mg²⁺+NH₄⁺+PO₄³⁻+6H₂O [symbol] MgNH₄PO₄.6H₂O

Examples of reactors used to remove and recover phosphorus from wastewater solutions have been described in various references. They include:
Regy et al., Phosphate recovery by struvite precipitation in a stirred reactor, LAGEP (March to December 2001) includes a survey of various attempts to remove phosphorus and nitrogen from wastewater by struvite precipitation.
Trentelman, U.S. Pat. No. 4,389,317 and Piekema et al., Phosphate Recovery by the Crystallization Process: Experience and Developments, paper presented at the 2^{nd} International Conference on Phosphate Recovery for Recycling from Sewage and Animal Wastes, Noordwijkerhout, the Netherlands, Mar. 12-13, 2001, disclose a reactor and method for precipitating phosphate in the form of calcium phosphate, magnesium phosphate, magnesium ammonium phosphate or potassium magnesium phosphate.
Ueno et al., Three years experience on operating and selling recovered struvite from full scale plant (2001), Environmental Technology, v. 22, p. 1373, discloses the use of sidestream crystallization reactors to remove phosphate in the form of magnesium ammonium phosphate (also known as struvite).
Tsunekawa et al., patent Abstracts of Japan No. 11-267665 discloses a reactor for removing phosphorus from water.
Koch et al., fluidized bed wastewater treatment, U.S. Pat. No. 7,622,047.

Some problems that may occur in reactors useful for precipitation of struvite or other similar materials include accumulation of floatable solid materials at or near the top of the reactor. Another problem is that struvite or scale having other compositions may form in effluent piping systems. A third problem is that adding alkaline chemicals to adjust the pH of wastewater in the reactor may result in undesirable costs. Therefore, there is a need for cost-effective methods and systems to address some or all of these problems.

### BRIEF DESCRIPTION OF THE DRAWINGS

The accompanying drawings illustrate non-limiting embodiments of the invention,

FIG. 1 is a diagram of a reactor aeration system according to one example embodiment of the invention.

FIG. 1A is a diagram of a reactor aeration system according to another example embodiment of the invention.

FIG. 2 is a flow chart which illustrates a method of aerating wastewater in a reactor according to another example embodiment of the invention.

### DESCRIPTION

Throughout the following description, specific details are set forth in order to provide a more thorough understanding of the invention. However, the invention may be practiced without these particulars. In other instances, well-known elements have not been shown or described in detail to avoid unnecessarily obscuring the invention. Accordingly, the specification and drawings are to be regarded in an illustrative, rather than a restrictive, sense.

Some embodiments of the invention in the following description relate to aerated reactor apparatus or methods wherein phosphorus in an aqueous solution, which may comprise wastewater in some embodiments, is precipitated in the form of struvite or struvite analogs or a phosphate compound. This choice of example coincides with an aspect of the invention having significant commercial utility. The scope of the invention, however, is not limited to the examples given in this description.

For convenience, the term “wastewater” is used in the following description and claims to describe aqueous solutions such as industrial and municipal wastewater, leachate, runoff, animal wastes, effluent or the like. The term “wastewater” is not limited to effluent from municipal sewage, animal waste, or any other specific source. Some embodiments provide methods for treating municipal sewage and/or animal waste. Some embodiments provide methods and apparatus for treating other kinds of aqueous solutions from which struvite or struvite analogs or other phosphate compounds may be precipitated.

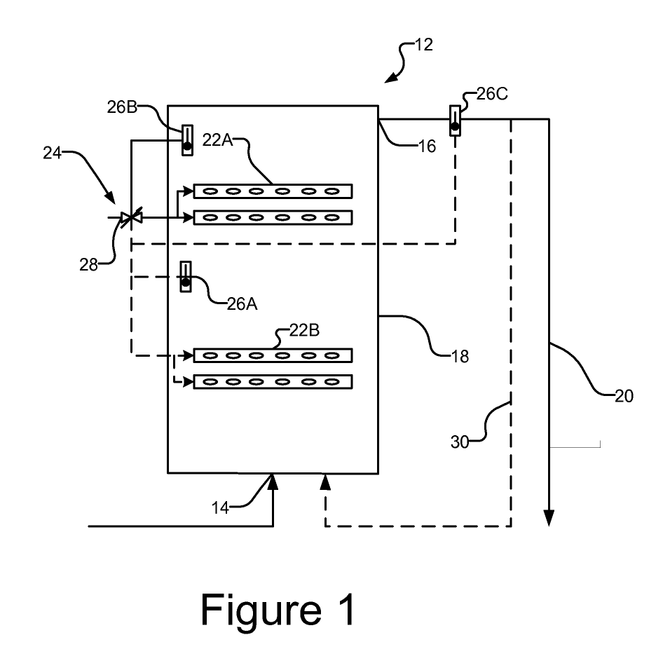

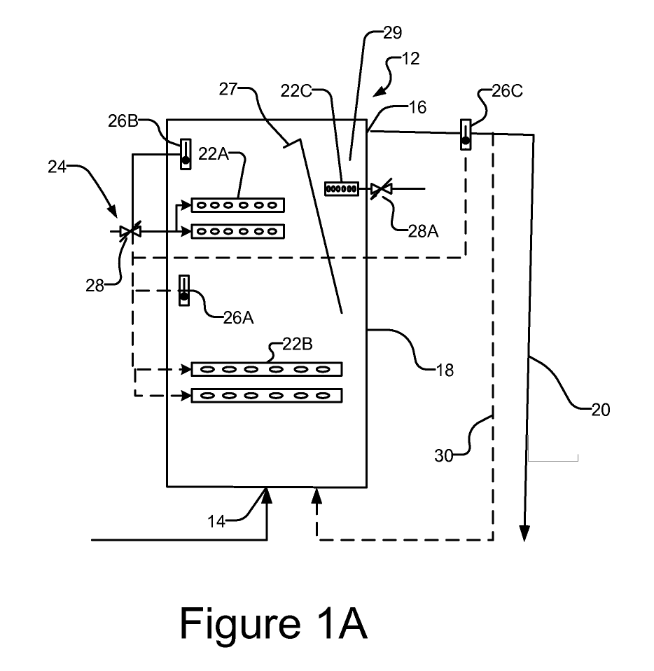

Some embodiments comprise a reactor with a top overflow through a quiescent zone (e.g., a settling section with flow slowing distribution structures such as weirs). For example, the reactor may comprise a fluidized bed reactor. FIG. 1 shows a reactor 12 according to one embodiment of the invention. Reactor 12 comprises an inlet 14, an outlet 16 and a reaction tank 18. Outlet 16 connects to an effluent piping system 20. A recycling path 30 may optionally be provided. Wastewater flows into reaction tank 18 through inlet 14 and flows out of reaction tank 18 through outlet 16. Some embodiments comprise a plurality of inlets and/or outlets. The inlet or outlet may be oriented either substantially vertical or substantially horizontal or at an angle to reaction tank 18.

Inlet 14 may be located, for example, in or near the lower portion of reaction tank 18. Outlet 16 may be located, for example, in or near the upper portion of reaction tank 18. In some embodiments inlet 14 is directed upwardly and flow of fluid introduced from inlet 14 into reactor 16 is directed upwardly.

In some embodiments, upflow of fluid in a reactor supports pellets of struvite or other phosphorus-containing compounds which form in the reactor through precipitation of dissolved materials. Pellets may grow larger over time and may be sorted according to size by differences in fluid flow rates in different regions within the reactor. For example, in some embodiments a fluid rate increases with depth in a reactor. In such embodiments pellets of struvite may move downward as they grow in size (through accretion and/or aggregation with other pellets). The pellets may ultimately enter a harvesting zone from which they may be removed for use as fertilizer or other applications.

Recycling path 30, if present, may be connected to receive or withdraw wastewater from tank 18 and to return the wastewater to tank 18. In some embodiments, recycling path 30 returns wastewater to tank 18 below a location at which the wastewater was received from tank 18. In some embodiments, recycling path 30 shares inlet 14 and outlet 16. In other embodiments, recycling path 30 has one or more inlets separate from outlet 16 and/or one or more outlets into tank 18 separate from inlet 14.

In some embodiments, reaction tank 18 comprises a substantially vertically-oriented conduit having a harvesting section and at least two vertically-sequential sections above the harvesting section. A cross-sectional area of the conduit may increase moving from the bottom of tank 18 toward the top of tank 18. For example, the cross sectional area may increase between adjacent ones of the sections or the tank may have a continuously expanding cross section (as in the case of a conical tank for example). In some embodiments the cross-sectional area increases stepwise. The number of sections in the conduit may be varied.

Inlet 14 may be located in or below the harvesting section for example. Some embodiments may comprise a fluidized bed reactor of the type described in Koch et al., U.S. Pat. No. 7,622,047, entitled “Fluidized Bed Wastewater Treatment”, which is hereby incorporated by reference. Example embodiments include any embodiment of reactor as described in U.S. Pat. No. 7,622,047 modified by the addition of aeration systems as described below.

When treating wastewater containing floatable materials or solids with specific gravity approximately equal to or less than that of the wastewater being treated there is potential for accumulation of floatable solid materials at or near the top of reaction tank 18. Floatable solid materials tend to be retained by flow distribution structures such as overflow weirs. This can result in the need to periodically or continuously remove these solids to prevent obstruction or clogging of the treatment system and process failures. Types of wastewater which tend to produce or carry significant amounts of floatable solids include wastewaters such as sludge dewatering liquors, particularly those resulting from centrifugation (centrate), and industrial wastes such as stillage from ethanol production, and many food processing wastes.

In systems for treating wastewater containing dissolved materials that tend to precipitate at higher pH levels, scale formation in effluent piping can be a problem. An example is a system for recovery of phosphate in the form of struvite from liquid effluents of anaerobic processes (e.g., anaerobic digester liquors, dewatering liquors at municipal wastewater treatment plants, etc.). In such systems, struvite formation may be encouraged as a result of pH increases which can occur when carbon dioxide is released from the wastewater.

Carbon dioxide tends to be released when wastewater cascades down drains or flows in partially full drain pipes in the effluent piping system. Carbon dioxide is typically present at elevated levels in entering wastewater due to the high fraction of carbon dioxide in the sealed atmosphere in anaerobic treatment tanks that may precede the phosphorus recovery process in a wastewater treatment plant. Once the wastewater is exposed to ambient air, and especially when mixed turbulently with air, the carbon dioxide tends to offgas, causing pH increase in the wastewater. The solubility of struvite is a function of pH and decreases when pH increases. As pH increases, struvite precipitates from the wastewater. The carbon dioxide offgassing and the resultant pH increase can therefore lead to increased struvite scale formation in the effluent piping system downstream from a reactor.

In struvite/phosphate recovery systems pH can be controlled to promote the formation of struvite in a reactor and to reduce effluent phosphate levels. The carbon dioxide that can be present at elevated levels in the wastewater results in low pH conditions that are unfavorable to the formation of struvite in reaction tank 18. In order to counter this problem, one can add alkaline (basic) substances such as sodium hydroxide (NaOH), magnesium hydroxide (Mg(OH)₂), ammonium hydroxide (NH₄OH) anhydrous ammonia (NH₃) or the like to the system in or upstream from the reaction tank to increase the pH of the wastewater and to promote struvite formation in the reaction tank. However, purchasing such materials and supplying and maintaining equipment to introduce such materials into the process adds to the cost of operating a wastewater treatment system.

One aspect of the invention provides methods and systems operable to break up floatable solid materials accumulating at or near the top of the reaction tank. Another aspect of the invention provides methods and systems operable to strip (i.e., remove) carbon dioxide from wastewater in a reaction tank so as to reduce the formation of scale in the effluent piping system and/or to increase the yield of struvite or another precipitate. A further aspect of the invention provides methods and systems to reduce or eliminate the use of alkaline chemicals to control pH by stripping carbon dioxide from wastewater within a reactor. These aspects of the invention may be exploited either individually or in any combination.

One aspect of the invention provides a reactor equipped with an aeration system and a wastewater treatment system which includes such a reactor. FIG. 1 shows an aeration system according to one embodiment of the invention. The system comprises one or more air diffusers 22A and 22B (collectively 22) located in a reaction tank 18. In the illustrated embodiment, air diffusers 22A and 22B are located below outlet 16 of reaction tank 18. Air diffusers 22 are positioned at a suitable height or heights (or equivalently at suitable depths below the fill line of reaction tank 18) in reaction tank 18. In some embodiments, air diffusers 22 are positioned near the top of reaction tank 18 (for example 1 metre or less below a fill level of reaction tank 18 in some embodiments, 50 to 100 cm or 200 cm below the fill level of tank 18). In some embodiments, air diffusers 22 are positioned 50 to 200 centimetres below outlet 16. In some embodiments air diffusers 22 are located above a harvesting zone of reaction tank 18. In other embodiments some or all air diffusers 22 may be located deeper in reaction tank 18. In some embodiments different sets of air diffusers 22 are provided at different elevations within reaction tank 18.

In some embodiments, some or all of diffusers 22 may be located within a reactor section separated from the outlet 16 of reaction tank 18 by a baffle. The baffle may have the effect of reducing turbulence and improving settling in an outlet section of reaction tank 18 (on another side of the baffle from diffusers 22). Such a baffle may be particularly advantageous in applications where it is not expected that there will be significant accumulations of floatable solids in the outlet section of reaction tank 18. In some embodiments, diffusers present in the outlet portion of reaction tank 18 are independently controllable to break up accumulations of floatable solids in the outlet portion of the tank. Diffusers 22 separated from the outlet portion of the tank by the baffle may be controlled by a controller to achieve a desired pH adjustment or a desired removal of CO₂.

FIG. 1A shows an example embodiment that is similar to the embodiment of FIG. 1 with the addition of a baffle 27 that defines an outlet portion 29. Diffusers 22C are present in or below outlet portion 29. Air supply to diffusers 22C is controlled by a valve 28A. Valve 28A may be manually operated to break up floating solids or controlled by a controller (not shown).

To increase the amount of carbon dioxide stripped from the wastewater by a given flow of stripping gas, air diffusers 22 may be positioned deeper in reaction tank 18, for example, at or near the bottom of reaction tank 18 or just above a harvesting zone in reaction tank 18. To better break up floating solids, air diffusers 22 may be positioned closer to the top of reaction tank 18. In some embodiments, air diffusers 22 are located above a harvesting section of reaction tank 18. In some embodiments a number of air diffusers 22 are distributed generally symmetrically around a central axis of reaction tank 18. In some embodiments air diffusers 22 are approximately ½ way between the central axis and a wall of reaction tank 18.

When multiple air diffusers are present, air diffusers 22 may be positioned side by side or at different heights relative to each other and can be organized either in tandem or in parallel or other configurations. In some embodiments, one set of air diffusers 22A is provided near the top of reaction tank 18 and another set of air diffusers 22B is provided deeper inside reaction tank 18. Air flow to diffusers 22A and 22B may be controlled jointly or separately.

The stripping gas delivered through air diffusers 22 may comprise, for example, air, an inert gas, nitrogen, or combinations thereof. The stripping gas may be delivered from a source of pressurized gas such as a compressed gas tank, a blower, a compressor, or other suitable means. The system further comprises one or more airflow controllers 24 that controls the flow of gas to diffusers 22 to accomplish a desired level of CO₂ stripping, a desired level of pH increase in reaction tank 18, and/or a desired breakup of floating solids.

Airflow controller 24 may comprise one or more probes 26A, 26B, 26C (collectively probes 26) and a metering mechanism 28. Probes 26 are located at suitable points in the wastewater treatment system. In embodiments with multiple probes 26, probes 26 may be located at more than one location, e.g., at locations in the reaction tank and/or the effluent piping system. Probes 26 measure one or more physical characteristics of the wastewater and send a signal to metering mechanism 28. Metering mechanism 28 may comprise, for example, a programmable process controller configured to control flow of gas to diffusers 22 based at least in part on signals from probes 26. Probes 26 may comprise pH probes or CO₂ partial pressure probes or both. In some embodiments, probes 26 comprise electrical conductivity probes. In one embodiment, at least one probe 26 is provided at or downstream from an outlet 16 of reaction tank 18. In an example embodiment the process controller is configured to increase the flow of stripping gas through diffusers 22 (the time-averaged flow in some cases) in response to detection of a pH below a first threshold and to decrease or shut off the flow of stripping gas in response to detection of a pH above a second threshold.

Metering mechanism 28 adjusts the amount of stripping gas released by air diffusers 22 in response to signals from probes 26. Any suitable metering mechanisms may be used to control the airflow. Such metering mechanisms may include, for example, variable speed blowers, compressors, control valves, cyclical on-off control or the like. Metering mechanism 28 may be controlled to achieve a specific flow rate of air or another stripping gas as measured by a suitable flowmeter. A wide range of suitable metering mechanisms are available commercially. In some embodiments flow controllers 24 comprise electrically controllable valves and metering mechanism 28 comprises an electronic process controller (which may be a programmable electronic process controller) configured and connected to control the valves.

In some embodiments process conditions may be sufficiently constant that airflow controller 24 does not require an active controller that continuously monitors and responds to wastewater conditions. In some embodiments airflow controller 24 may comprise a suitable manually controlled metering mechanism 28 that can be set to deliver a desired flow or flows of stripping gas through air diffusers 22. In some embodiments the flow of stripping gas through air diffusers 22 is controlled to maintain a rate of the inflow of fresh wastewater to the flow of stripping gas in a desired range.

The agitation caused by bubbles of gas released from air diffuser 22 may result in the breakup of any accumulated floatable solids layer while the aeration strips carbon dioxide from the wastewater resulting in increased pH in reaction tank 18 and reduced potential for pH increases resulting from carbon dioxide stripping in downstream piping systems 20. Precipitation of dissolved materials in reaction tank 18 may be enhanced in the effluent with increased pH. Some of the effluent from above air diffusers is optionally recycled to the base of reaction tank 18 through recycling path 30, resulting in further increase in the system pH (and a potential consequent increase in phosphorus/struvite recovery rates), or a reduction in demand for alkaline chemicals for operation, or both. The recycle ratio (e.g., ratio of flow through recycle path 30 to flow of incoming wastewater) may be monitored and controlled. Some embodiments comprise a control system, such as a process controller, configured to control both a recycle ratio and flows of stripping gas through one or more air diffusers.

In embodiments which include some shallower air diffusers 22 and some deeper air diffusers 22 then control of pH in reaction tank 18 may comprise, at least in part, adjustment of the relative rate of flow of stripping gas through the deeper and shallower air diffusers 22. In response to detecting a lower pH, a controller may direct proportionately more stripping gas to deeper air diffusers 22. In response to detecting a higher pH, the controller may direct proportionately more stripping gas to shallower air diffusers 22 near the surface of liquid in reaction tank 18.

Stripping of carbon dioxide from the wastewater may also be applied to raise pH in cases where the wastewater is over-saturated with carbon dioxide, such as when treating effluents from anaerobic processes. Stripping carbon dioxide from such wastewater may reduce or eliminate the need to add alkaline substances to the system to achieve a desired pH or may allow higher treatment efficiency for a given input of alkaline materials. This may result in both operational cost savings and potential increased struvite production.

In some embodiments, air diffusers 22 comprise flexible membrane diffusers. Such diffusers may advantageously tend to shed any struvite scale accumulation which may form near the point of air release from diffuser 22. Diffusers 22 are preferably constructed to prevent backflow of wastewater into air piping when shut off. For example, coarse bubble membrane diffusers which are capable of preventing wastewater backflow into the air piping when air flow is shut off, such as SnapCap™ diffusers available from Siemens, may be used. Such diffusers facilitate cyclical operation of the aeration system in response to a pH or other control signal, to help control the crystallization conditions (e.g. supersaturation ratio for a material to be precipitated) within the reactor. Open pipe or perforated pipe diffusers may also be applied. Such open diffusers are advantageously oriented to avoid contacting CO₂-stripped wastewater in a manner that could result in encrustation of the piping system with struvite. Mounting diffusers such that bubbles rise vertically away from the piping and diffusers is desirable.

By stripping most of the carbon dioxide from the wastewater within tank 18 the potential for further offgassing in effluent piping system 20 or recycling path 30 is drastically reduced, thereby reducing or eliminating the potential for problematic struvite scale formation in the drain and downstream processes. In some embodiments a concentration of dissolved CO₂ in wastewater at outlet 16 may be reduced by 50% or more relative to the concentration of CO₂ being introduced at inlet 14. Because the offgassing and pH increase occurs in reaction tank 18, the formation of struvite or other precipitates is controlled and may result in minimal unwanted struvite scale formation, but increased struvite yield and/or reduced alkaline chemical consumption for process pH control.

In some embodiments, the surface area of diffuser openings is approximately 9 cm² with an airflow rate of approximately 10 to 20 litres/second of stripping gas for a vessel treating approximately 100 to 300 litres/minute of wastewater, or approximately 2 to 12 litres of stripping gas per litre of wastewater treated.

A prototype comprising very coarse bubble systems (open pipe discharge ranging from 0.25 inch to 1 inch in diameter) has been built and tested. Table 1 shows the results of one test with a 0.25-inch diameter open pipe diffuser located approximately 75 centimetres below the top of a tank having an area section of approximately 10 square metres and a depth of approximately 5 metres. The diffuser was operated with air at approximately 60-80 pounds per square inch. The prototype is capable of raising the operating pH of the reactor by up to 0.8 pH unit while breaking up a mat of floatable solids floating near or at the top of the reaction tank and reducing struvite scale formation in the effluent piping system.

TABLE 1
pH change in the reactor as a result of aeration

| | pH in reactor harvest | pH in reactor overflow/ |
|---|---|---|
| Time (minutes) | section | recycle region |
| 0 (start air flow) | 7.11 | 7.15 |
| 5 | 7.19 | 7.19 |
| 10 | 7.31 | 7.22 |
| 15 | 7.42 | 7.24 |
| 20 | 7.52 | 7.27 |
| 25 | 7.55 | 7.29 |
| 30 | 7.59 | 7.32 |
| 35 | 7.65 | 7.34 |
| 40 | 7.68 | 7.37 |
| 50 | 7.73 | 7.40 |
| 69 | 7.74 | 7.44 |
| 102 | 7.73 | 7.48 |
| 112 | 7.72 | 7.49 |
| 159 | 7.64 | 7.52 |
| 175 | 7.62 | 7.51 |
| 207 | 7.59 | 7.52 |
| 235 | 7.60 | 7.53 |
| 236 (stop air flow) | | |
| 275 | 7.25 | 7.34 |

In some embodiments, the reactor aeration system is configured to maintain the pH of the wastewater in the reaction tank in the range of 7.0 to 8.5. In some embodiments, the reactor aeration system maintains the pH of the wastewater in the reaction tank at or above 8.3. The reactor aeration system may also be used when the wastewater pH is below 7.0. In cases where the wastewater pH is low for struvite formation (e.g. lower than pH 6.0), the reactor aeration system may be operated to increase the wastewater pH to reduce the need to use alkaline chemicals for pH adjustment.

In some embodiments the reactor aeration system is configured to control alkalinity or buffering capacity. Operation of the reactor aeration system to remove CO₂ from the solution in the reactor tends to reduce the total alkalinity and to thereby reduce the amount of acid or base respectively required to lower or raise the pH of the solution. In some embodiments a controller controls the reactor aeration system in response to a signal indicative of total alkalinity from a suitable alkalinity monitor. The aeration system may be turned on (or operated at an increased level) in response to an increase in alkalinity and turned off (or operated at a decreased level) in response to a decrease in alkalinity. FIG. 1 shows an alkalinity probe 26A.

In some embodiments the reactor aeration system is configured to operate in response to a signal from a sensor monitoring carbon dioxide concentration in a head space of the reaction tank. In such embodiments the headspace may comprise an enclosed space ventilated by a ventilation system such that the concentration of carbon dioxide in the headspace is indicative of the rate at which carbon dioxide is evolving from the reaction tank. In an example embodiment the rate that stripping gas is introduced by way of the aeration system is controlled to maintain a target carbon dioxide concentration in the headspace. FIG. 1 shows a carbon dioxide concentration probe 26B located in a headspace of reaction tank 18.

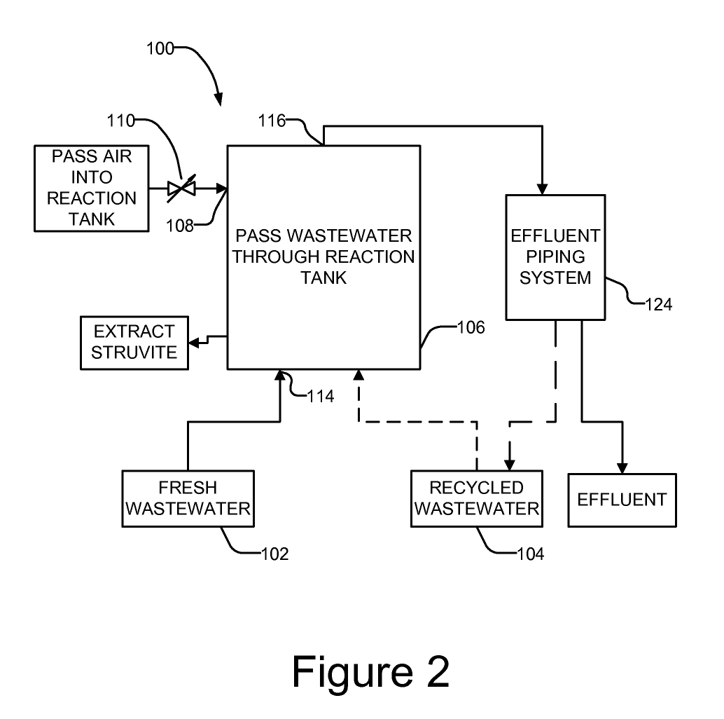

FIG. 2 illustrates a method 100 according to an example embodiment of the invention. Method 100 takes fresh aqueous solution such as, for example, wastewater 102 or recycled wastewater 104 (optional) and passes the wastewater into a reaction tank 106. Method 100 comprises maintaining one or more air diffusers 108 in reaction tank 106 below an outlet 116 that leads to the effluent piping system 124. The method further comprises passing air, an inert gas or nitrogen into the wastewater in reaction tank 106 through air diffusers 108. A control device 110 continuously controls the airflow to air diffusers 108 to accomplish a desired level of carbon dioxide removal, a desired level of alkalinity in the wastewater, and/or a desired level of pH in the wastewater.

In some embodiments of the method, the pH of the wastewater is increased by 0.1 pH unit or more. In some embodiments of the method, the pH of the wastewater is increased by 0.5 pH unit or more. In some embodiments of the method, the pH of the wastewater is increased by 1.0 pH unit or more. In some embodiments of the method, the concentration of carbon dioxide in the wastewater is reduced by 10% or more. In some embodiments of the method, the concentration of carbon dioxide in the wastewater is reduced by 50% or more. In some embodiments of the method, the concentration of carbon dioxide in the wastewater is reduced by at least 90%.

In some embodiments of the method, the pH of the wastewater in reaction tank 106 is maintained between 7.0 and 8.5. In other embodiments of the method, the pH of the wastewater in reaction tank 106 is maintained above 8.3. In some embodiments control of pH is provided by controlling the introduction of gas into reaction tank 106 via diffusers 108. In some embodiments the gas introduction reduces the concentration of dissolved carbon dioxide in wastewater by 75% or more. For example, [CO₂] in wastewater exiting at outlet 116 may be 25% or less of [CO₂] in wastewater entering the system at inlet 114.

The agitation caused by the bubbles from air diffusers 108 may cause or assist in the breakup of an accumulated floatable solids layer at or near the top of reaction tank 106, while the bubbles of stripping gas strip carbon dioxide from the wastewater resulting in increased pH and reduced potential for scale formation in the effluent piping system 124. Some of the effluent with increased pH is optionally recycled into the reactor (e.g. to the base of the reactor) in systems where the recycled wastewater is used, resulting in an increase in the system pH (and consequent increase in phosphorus/struvite recovery rates), or a reduction in demand for alkaline chemicals for operation, or both.

Effluent from reaction tank 106 is taken away through outlet 116 and effluent piping system 124. Periodically pellets of struvite or struvite analogs or phosphate compounds are extracted from reaction tank 106. The pellets may be extracted from a harvesting section of reaction tank 106. In some embodiments valves or the like are provided to permit the harvesting section to be isolated from the rest of reaction tank 106 while pellets of material are removed from the harvesting section.

Methods and apparatus as described herein may be used in combination with methods and apparatus as described in Koch et al., U.S. Pat. No. 7,622,047, which is hereby incorporated herein by reference. For example, a reaction tank 18 may be configured as described by Koch et al.

As will be apparent to those skilled in the art in the light of the foregoing disclosure, many alterations and modifications are possible in the practice of this invention without departing from the spirit or scope thereof.

What is claimed is:

1. A treatment system for use in removing solutes from aqueous solutions, the reactor comprising:
a reaction tank;
an inlet for an aqueous solution to enter the reaction tank;
an outlet in an upper portion of the reaction tank; and
an aeration system in the reaction tank below the outlet, said aeration system comprising one or more air diffusers operable to diffuse a stripping gas into the reaction tank and an airflow control mechanism configured to control a flow of the stripping gas through the diffusers.

2. A treatment system according to claim 1, further comprising a recycling path for removing aqueous solution from the reaction tank and returning at least part of the removed aqueous solution to the reaction tank.

3. A treatment system according to claim 2, wherein the recycling path extends from the outlet of the reaction tank to the inlet of the reaction tank.

4. A treatment system according to claim 1, wherein the air diffusers comprise one or both of flexible membrane diffusers or coarse bubble membrane diffusers.

5. A treatment system according to claim 1, wherein the stripping gas is selected from the group consisting of air, an inert gas, nitrogen and combinations thereof.

6. A treatment system according to claim 1, wherein the airflow control mechanism comprises means for automatically controlling the flow of the stripping gas from the diffusers.

7. A treatment system according to claim 6, wherein the airflow control mechanism is configured to automatically control the flow of stripping gas in response to a signal from a sensor measuring the pH of the aqueous solution the alkalinity of the aqueous solution or the concentration of dissolved carbon dioxide in the aqueous solution.

8. A treatment system according to claim 6, wherein the airflow control mechanism is configured to automatically control the flow of stripping gas in response to a signal from a sensor measuring the concentration of carbon dioxide in a headspace of the reaction tank.

9. A treatment system according to claim 7, wherein the airflow control mechanism is configured to increase the flow of stripping gas in response to one or more of a decrease in pH an increase in alkalinity or an increase in the concentration of dissolved carbon dioxide.

10. A treatment system according to claim 1 wherein the reaction tank comprises a baffle separating a main body of the reaction tank from an outlet portion of the reaction tank and at least some of the diffusers are located in a part of the reaction tank separated from the outlet portion by the baffle.

11. A treatment system according to claim 10 comprising an independent control system operable to operate additional diffusers present in the outlet portion of the reaction tank.

12. A treatment system according to claim 1, wherein the system is configured to maintain the aqueous solution pH between 7.0 and 8.5.

13. A treatment system according to claim 1, wherein the aeration system is operable to break up accumulations of floatable solids on the top of the reaction tank.

14. A treatment system according to claim 1 wherein the air diffusers are located 50 to 200 cm below a fill level of the reaction tank.

15. A method for treating an aqueous solution, the method comprising:
introducing the aqueous solution into a reaction tank;
providing one or more air diffusers in the reaction tank below an outlet of the reaction tank, said air diffusers capable of diffusing a stripping gas into the aqueous solution;
controlling a flow of the stripping gas from the diffusers to the tank to decrease a concentration of carbon dioxide in the aqueous solution or to increase the pH of the aqueous solution to a level that favours the formation of struvite in the reaction tank; and
extracting struvite pellets formed in the reaction tank.

16. A method according to claim 15, comprising controlling the flow of the stripping gas to reduce the concentration of carbon dioxide in the aqueous solution by 10% or more.

17. A method according to claim 15, comprising controlling the flow of the stripping gas to reduce the concentration of carbon dioxide in the aqueous solution by 50% or more.

18. A method according to claim 15, comprising controlling the flow of the stripping gas to increase the pH of the aqueous solution in the reaction tank by 0.1 pH unit or more.

19. A method according to claim 18, comprising controlling the flow of the stripping gas to increase the pH of the aqueous solution in the reaction tank by 0.5 pH unit or more.

20. A method according to claim 15, comprising maintaining the pH of the aqueous solution between 7.0 and 8.5.

21. A method according to claim 15, wherein the stripping gas is selected from the group consisting of air, an inert gas, nitrogen and combinations thereof.

22. A method according to claim 15, comprising controlling the flow of stripping gas to break up an accumulation of floatable solids on the top of the reaction tank.

23. A method according to claim 15 wherein the aqueous solution comprises wastewater.

24. A method according to claim 15 wherein the reaction tank comprises a baffle separating a main body of the reaction tank from an outlet portion of the reaction tank, the diffusers include diffusers within the outlet portion of the reaction tank and the method comprises controlling the diffusers within the outlet portion of the reaction tank independently of other ones of the diffusers.

25. A method according to claim 24 comprising operating the diffusers within the outlet portion of the reaction tank to break up accumulated floating solids and operating the other ones of the diffusers to control one or both of pH and CO₂ content of the aqueous solution.
